(19) United States
(12) Patent Application Publication
(10) Pub. No.: US 2024/0304984 A1
(43) Pub. Date: Sep. 12, 2024

(54) TIMEPIECE MODULE AND ELECTRONIC TIMEPIECE

(71) Applicant: CASIO COMPUTER CO., LTD., Tokyo (JP)

(72) Inventors: Munetaka SEO, Tokyo (JP); Takeshi MATSUE, Tokyo (JP); Jun MIWA, Tokyo (JP)

(73) Assignee: CASIO COMPUTER CO., LTD., Tokyo (JP)

(21) Appl. No.: 18/599,987

(22) Filed: Mar. 8, 2024

(30) Foreign Application Priority Data
Mar. 9, 2023 (JP) 2023-036201

(51) Int. Cl. H01Q 1/27; G04G 17/04; G04G 17/08

(52) U.S. Cl. CPC H01Q 1/273; G04G 17/04; G04G 17/08

(57) ABSTRACT

A timepiece module includes a circuit board having a first surface, a plate-like antenna and a metal member. The antenna extends in a direction to be away from the first surface of the circuit board. The metal member is entirely disposed outside a first region and outside a second region. The first region extends from a plate surface of the antenna outward in a normal direction of the antenna. The second region coincides with the antenna in plan view viewed from above the first surface.

### TECHNICAL FIELD

The present disclosure relates to a timepiece module and an electronic timepiece.

### DESCRIPTION OF RELATED ART

In a portable electronic device, an electronic wristwatch or the like in particular, which is required to be small and light to be worn on a wrist or the like, an antenna element used for transmission/reception of communication radio waves is likely influenced by other metal members or the like. It is therefore necessary, in such an electronic device, to devise a space where an antenna element is arranged.

There is known a technique for gaining the sensitivity of an antenna by expanding the substantial size of an antenna, using a plate-like antenna. Meanwhile, there is disclosed, for example, in JP 2018-146240 A a technique of not arranging metal components such as a receiving circuit and a control circuit in a no-arrangement region that exerts an influence on an electric field generated around a planar antenna (patch antenna) disposed on the opposite side of a substrate (board) from the side where a display surface is provided.

### SUMMARY OF THE INVENTION

According to an aspect of the present disclosure, there is provided a timepiece module including:
a circuit board having a first surface;
a plate-like antenna extending in a direction to be away from the first surface of the circuit board; and
a metal member entirely disposed outside a first region that extends from a plate surface of the antenna outward in a normal direction of the antenna and outside a second region that coincides with the antenna in plan view viewed from above the first surface.

Further features of the present invention will become apparent from the following description of exemplary embodiments (with reference to the attached drawings).

### BRIEF DESCRIPTION OF DRAWINGS

The accompanying drawings are not intended as a definition of the limits of the present disclosure but illustrate embodiments of the present disclosure, and together with the general description given above and the detailed description of embodiments given below, serve to explain the principles of the present disclosure, wherein:

FIG. 1A is a front view of an electronic timepiece including a timepiece module of an embodiment;

FIG. 1B is a sectional view of the electronic timepiece;

FIG. 2A is a top view of the timepiece module;

FIG. 2B is a top view of a circuit board;

FIG. 3 is an illustration to explain the timepiece module;

FIG. 4A is a perspective view showing the structure of an antenna;

FIG. 4B is an illustration to explain the position of the antenna;

FIG. 5A shows another embodiment of the timepiece module;

FIG. 5B shows the lower surface of the timepiece module of the embodiment; and

FIG. 6 shows another embodiment of the timepiece module.

### DETAILED DESCRIPTION

Hereinafter, one or more embodiments will be described with reference to the drawings.

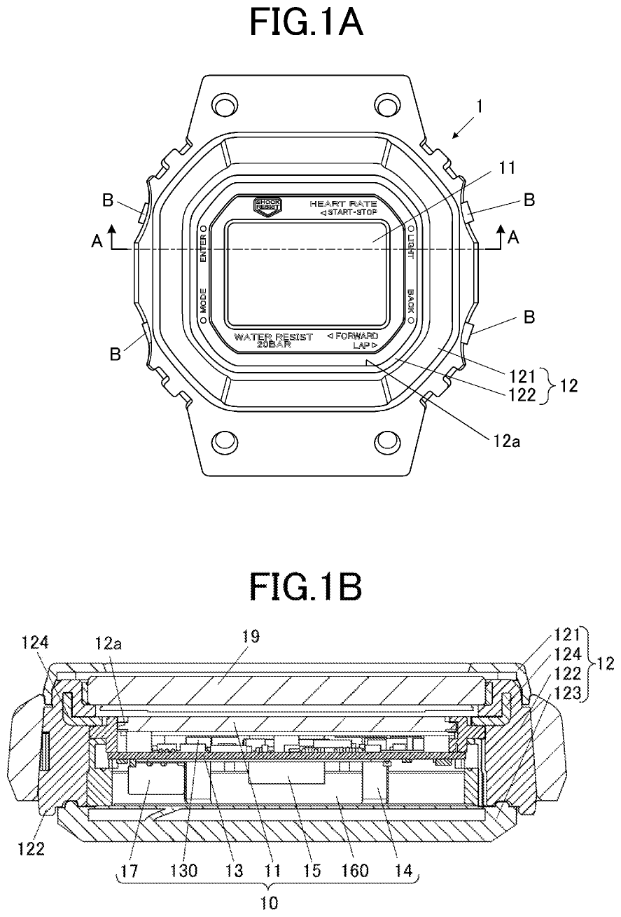

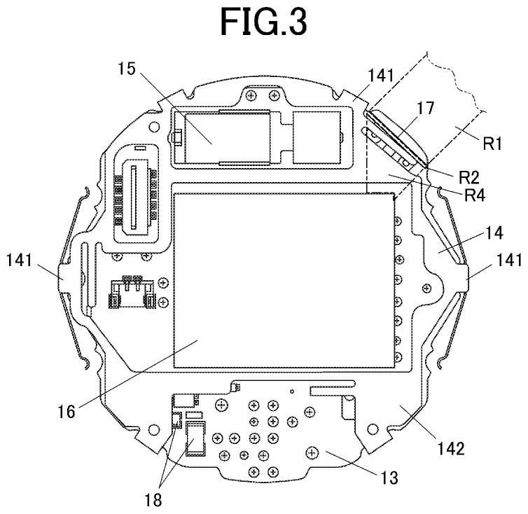

FIG. 1A and FIG. 1B show an electronic timepiece 1 including a timepiece module of a first embodiment. FIG. 1A is a front view of the electronic timepiece 1. FIG. 1B is a sectional view taken along a line A-A shown in FIG. 1A. In this sectional view, a battery 16 (shown in FIG. 3), which will be described below, is omitted for convenience.

In each front view (top view) or bottom view, the upper end corresponds to twelve o'clock position. Between front views (top views) and bottom views, three o'clock position and nine o'clock position are reversed horizontally.

The electronic timepiece 1 is wristwatch-shaped, and includes a timepiece module 10, a casing 12 (case) and a crystal 19. The lateral surface of the casing 12 is provided with pushbutton switches B passing through the casing 12.

The casing 12 houses and protects the timepiece module 10. The casing 12 is open on a side corresponding to the upper surface (display surface) side of the electronic timepiece 1 for the display surface of a display 11 (digital display), thereby having an opening 12a. Through this opening 12a, information/data (contents) displayed on the display screen is visible from the outside. The upper end (top end) of the casing 12 is sealed and covered with the transparent crystal 19. The casing 12 includes a bezel 121, a case body 122, a back cover 123 and an interior cover 124. The electronic timepiece 1 may further have an exterior member around the casing 12 for the purpose of decoration or the like.

The lower surface (bottom) side of the casing 12 may not be open. In this case, the casing 12 may not include the back cover 123.

The bezel 121 is exposed on the outer surface (upper surface) of the electronic timepiece 1. The bezel 121 reduces a shock when the electronic timepiece 1 falls, for example.

The case body 122 covers at least the side (lateral side) of the timepiece module 10. The case body 122 has attachment parts in the upward and downward directions (i.e., at twelve o'clock and six o'clock) in terms of display on the display screen. To the attachment parts, a band or the like is attached for a user to wear the electronic timepiece 1 on his/her wrist (arm).

The interior cover 124 includes a part disposed near the corner of the timepiece module 10 on the side where the opening 12a is provided, along the outer surface of the timepiece module 10. The interior cover 124 fixes the timepiece module 10 to the case body 122, thereby supporting the timepiece module 10. The interior cover 124 may be integrated with the case body 122.

The casing 12 is insulating, for example, made of resin. The resin may contain carbon, silicon or the like suitable for the strength, design, decoration and/or the like desired. The bezel 121 and/or the back cover 123 may be a conductor (s), namely, a metal member (s) or the like, to be grounded through the user. If the bezel 121 is used as an antenna to receive or transmit radio waves of a frequency different from that of radio waves handled by an antenna plate 17, which will be described below, the bezel 121 is a metal conductor.

The timepiece module 10 includes the abovementioned display 11, a circuit board 13, an upper housing 130, a fixing member 14 (circuit pressing member), a vibration motor 15, a battery housing 160, and the abovementioned antenna plate 17 (plate-like antenna).

Although not particularly limited, the display 11 has a digital display screen and performs digital display (digital presentation). The digital display screen is, for example, a liquid crystal display (LCD) or an organic electro-luminescent (EL) display.

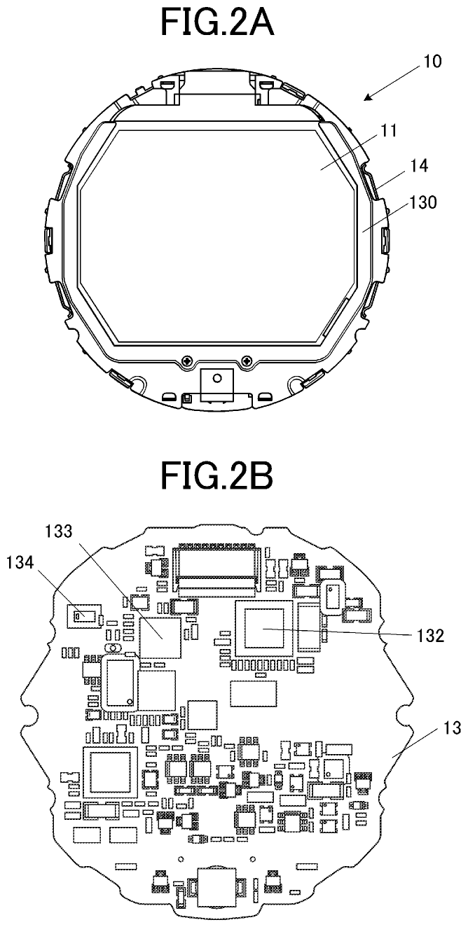

FIG. 2A, FIG. 2B and FIG. 3 are illustrations to explain the timepiece module 10.

FIG. 2A is a front view (top view) of the timepiece module 10. On the upper surface side of the timepiece module 10, the display screen of the display 11 is disposed. The display screen includes metal members (metal parts, metal components), such as electrodes of pixels and lines (wiring). The display screen is fixed to and held by the upper housing 130. The upper housing 130 houses a side of the circuit board 13 of the timepiece module 10, the side where the display screen is provided, and holds the display screen. The upper housing 130 may be a metal member in part or whole.

In the timepiece module 10, the fixing member 14 fixes components (a plurality of structures) all together that overlap one another in plan view viewed from above one of two surfaces (upper surface and lower surface) of the circuit board 13. The lateral surface of the fixing member 14 is provided with plate springs. The plate springs deform in response to presses on their corresponding pushbutton switches B mentioned above and are used for converting the presses into electric signals.

FIG. 2B is a top view of the circuit board 13.

The circuit board 13 may be a multi-layer substrate, for example, a substrate (board) having a circuit wiring on its interlayer (s). On the upper surface side of the circuit board 13, a large number of electronic components and so forth connected to a circuit wiring are disposed. The electronic components are disposed, in principle, on the upper surface side, namely, the side where the display 11 is provided. The electronic components include a control IC 132, a communication IC 133 and an antenna adjustment circuit 134.

The control IC 132 includes a processor that controls operation of the electronic timepiece 1 in whole. The control IC 132 controls calculation/measurement of the current time and display (e.g., digital presentation) that is performed by the display 11, which includes display of the current time.

The communication IC 133 outputs, to the control IC 132 or the like, signals generated by demodulating radio waves received by using the antenna plate 17 (shown in FIG. 3), and/or modulates signals to be transmitted by using the antenna plate 17 and outputs the signals to the antenna plate 17 or the like.

The antenna adjustment circuit 134 is, for example, a coil, and shortens the effective length of the antenna plate 17 for a receiving frequency so that the antenna plate 17 having a small size for the wavelength corresponding to the receiving frequency can receive radio waves at the receiving frequency. The receiving target is, for example, radio waves for short-range wireless communication, such as radio waves in 2.4 GHz band for Bluetooth® and WiFi.

FIG. 3 is a bottom view of the timepiece module 10, showing the lower surface (first surface) side of the timepiece module 10. The battery 16 is disposed substantially at the center of the lower surface side of the timepiece module 10. At twelve o'clock on the lower surface side of the timepiece module 10, the vibration motor 15 is disposed. The battery 16 is fixed by the battery housing 160, and each electrode thereof is connected to a power supply line or the like of the circuit board 13. In this embodiment, the battery 16 is a secondary cell fixed to the timepiece module 10 as one of the components that the timepiece module 10 has. However, the battery 16 may be a removable/replaceable dry cell, such as a button cell. The battery 16 may not be rectangular in plan view. The vibration motor 15 includes a weight that generates vibrations by rotating. The battery housing 160 may be made of metal in part.

On the lower surface of the circuit board 13, the antenna plate 17 is disposed at a corner space formed by the battery 16 and the vibration motor 15 in plan view outside the battery housing 160. Hereafter, the “plan view” is treated as being the same as the “bottom view” viewed from the side opposite to the abovementioned one of the two surfaces. The antenna plate 17 is electrically connected, by a line passing through the circuit board 13, to the antenna adjustment circuit 134 disposed on the upper surface of the circuit board 13.

As described above, no electronic components are disposed on the lower surface of the circuit board 13 except for connection terminals and extremely small electronic components 18 disposed on the opposite side of the vibration motor 15 and the battery 16 from the antenna plate 17 in plan view. It is determined that on the lower surface of the circuit surface 13, no electronic components are disposed around the antenna plate 17, at least between the battery 16 and the antenna plate 17 (fourth region R4) in plan view.

The fixing member 14 (circuit pressing member) partly covers the lateral surface of the timepiece module 10 from the rear surface side of the timepiece module 10, thereby holding the components of the timepiece module 10 all together. The fixing member 14 is a metal member and may constitute a case ground plane.

The fixing member 14 has a planar part 142 that spreads substantially parallel to the circuit board 13 and has holes, notches or the like so as not to overlap the vibration motor 15, the battery 16 and the antenna plate 17 in plan view. The fixing member 14 further has fitting parts 141 on its lateral surface. The fitting parts 141 are each fitted to at least one of the plurality of structures, for example, a projection of the upper housing 130, thereby fixing and holding the entire timepiece module 10. Although not particularly limited, each fitting part 141 may be a root part shared by two plate springs that deform in response to a press on a pushbutton switch B mentioned above.

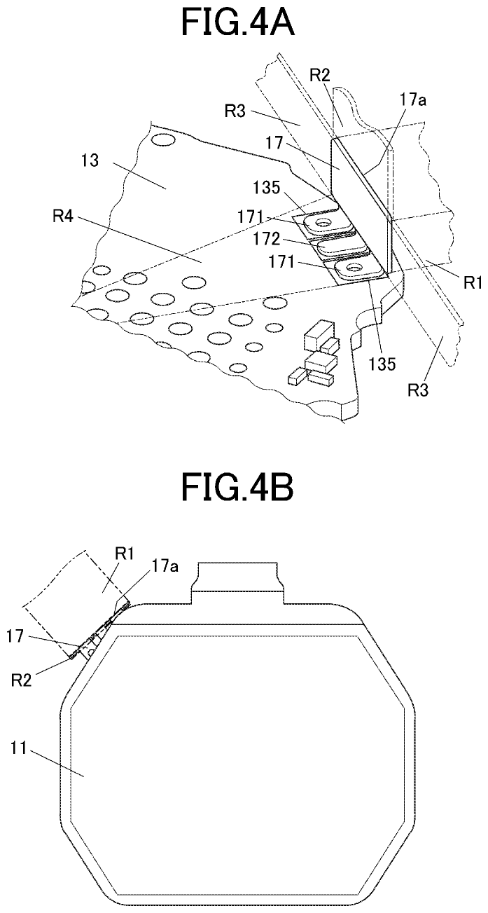

FIG. 4A and FIG. 4B are illustrations to explain the structure and the position of an antenna (antenna plate 17).

As shown in a perspective view shown by FIG. 4A, the antenna plate 17 is a plate-like conductive member that stands upright on the lower surface of the circuit board 13, namely, extends upright in a direction to be away from the lower surface of the circuit board 13. The width and the height of the plate surface 17a of the antenna plate 17 are sufficiently greater than the thickness of the antenna plate 17. The height of the antenna plate 17 is less than the length of a side of the antenna plate 17, the side being in contact with the lower surface of the circuit board 13. Thus, the antenna plate 17 has a height in the direction vertical to the circuit board 13 to obtain the area of a radio wave transmitting plane and/or a radio wave receiving plane. The antenna plate 17 is rigid to be stably upright and may be made of, for example, brass.

The antenna plate 17 is provided with legs 171 along the circuit board 13. The legs 171 are connected to electrode pads 135 on the circuit board 13. One of the electrode pads 135 is electrically connected to the antenna adjustment circuit 134 via a line (e.g., through-hole conductor) passing through the circuit board 13. The other of the electrode pads 135 is not connected anywhere. Thus, the antenna plate 17 is a monopole antenna. The legs 171 stably support the antenna plate 17 on the circuit board 13 in the upright state.

Between the two legs 171, a position adjustment part 172 is disposed. The position adjustment part 172 is a part that is disposed between the electrodes 135 so as not to be in contact with the electrode pads 135 when the antenna plate 17 is joined to the circuit board 13. Resist on the surface of the circuit board 13 may be removed at a part corresponding to the position adjustment part 172 so that the antenna plate 17 can be joined to the circuit board 13 more easily.

As described above, the antenna adjustment circuit 134 is connected to the antenna plate 17. The length (i.e., the abovementioned width) of the plate surface 17a of the antenna plate 17 is therefore shorter than λ/8 or the like of the transmitting/receiving frequency. That is, the antenna adjustment circuit 134 contributes to downsizing of the antenna plate 17.

No metal parts are disposed in a region extending from the plate surface 17a of the antenna plate 17 outward in its normal direction (first region R1 in the ten-thirty direction), namely, in front of the antenna plate 17. That is, metal parts other than the antenna plate 17 are all (entirely) disposed outside the first region R1. The metal parts of the timepiece module 10 may include, in addition to the electronic components on the circuit board 13, the fixing member 14 and the vibration motor 15, part of or the whole of each of the upper housing 130, the battery housing 160 and the display 11. Metal parts of the electronic timepiece 1 other than the metal parts of the timepiece module 10 may include the casing 12, which includes the bezel 121, the case body 122, the back cover 123 and the interior cover 124. The above arrangement suppresses disturbance of an electric field by the other metal parts, the electric field being relevant to transmission/reception of radio waves by the antenna plate 17. In particular, the fitting parts 141 of the fixing member 14, which extend on the lateral surface, not disposed in the region extending from the plate surface 17a of the antenna plate 17 outward in the normal direction makes it less likely for metal parts to interfere with transmission/reception of radio waves. It is noted that the “transmission/reception of radio waves” or similar expressions in the present disclosure means “transmission and/or reception of radio waves”.

Further, as described above, the fixing member 14 is disposed so as not to overlap the antenna plate 17 in plan view. Still further, as shown in FIG. 4B, the display screen does not overlap the antenna plate 17 in plan view. That is, metal members of the timepiece module 10 are entirely disposed outside a region that coincides with the antenna plate 17 in plan view (second region R2). In other words, in a plane containing the plate surface 17a of the antenna plate 17, no metal members other than the antenna plate 17 of the timepiece module 10 are disposed, at least in the upward and downward directions of the timepiece module 10. In the electronic timepiece 1 of the first embodiment, external components to the timepiece module 10, such as the back cover 123 and the interior cover 124, include parts disposed in the second region R2.

As described above, in the fourth region R4 between the antenna plate 17 and the battery 16 on the first surface of the circuit board 13 shown in FIG. 4A, no electronic components are disposed. A third region R3 extending sideways along the antenna plate 17 shown in FIG. 4A will be described below.

### [Other Embodiments]

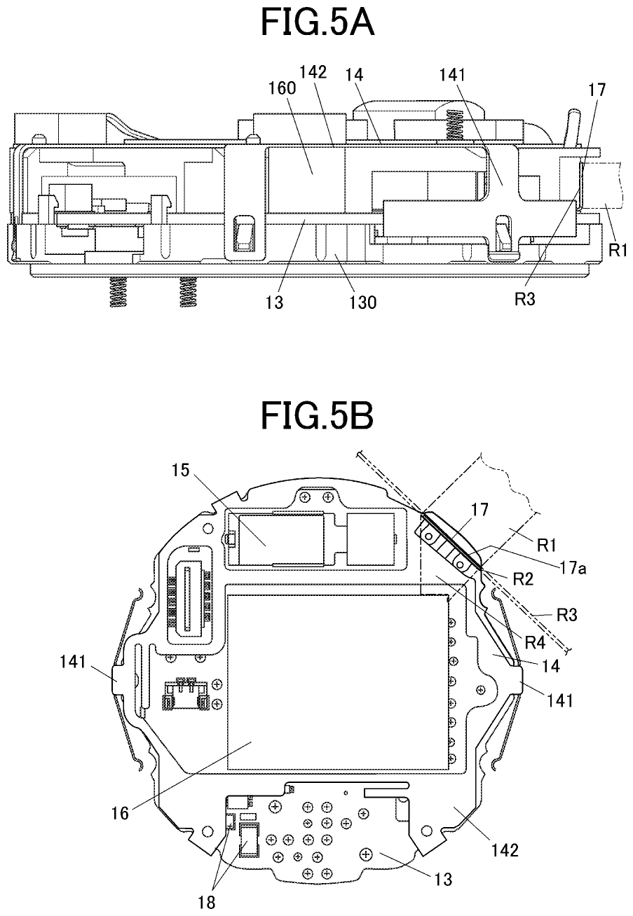

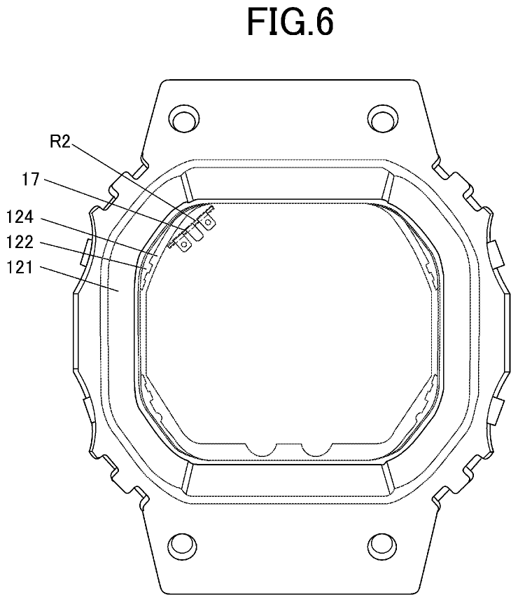

FIG. 5A, FIG. 5B and FIG. 6 show other embodiments of the timepiece module 10. FIG. 5A is a lateral view of the timepiece module 10 of the electronic timepiece 1 of a second embodiment. The timepiece module 10 of the second embodiment in FIG. 5A is viewed from the direction along the width of the plate surface 17a of the antenna plate 17. FIG. 5B is a bottom view of the timepiece module 10 of the second embodiment, showing the lower surface (first surface) side of the timepiece module 10.

The timepiece module 10 of the second embodiment is different from that of the first embodiment in that no metal members are disposed in the third region R3 that extends in the leftward and rightward directions of the antenna plate 17, namely, in the frontward and backward directions of the paper surface of FIG. 5A, too. In the first embodiment, as shown in FIG. 3, a fitting part 141 is disposed on the left of the plate surface 17a of the antenna plate 17. Meanwhile, in the second embodiment, as shown in FIG. 5B, this fitting part 141 has been removed (or moved). Thus, no metal members are disposed in the third region R3 (shown in FIG. 4A, FIG. 5A and FIG. 5B) defined by extending the antenna plate 17 parallel to the first surface and the plate surface 17a of the antenna plate 17 of the timepiece module 10.

According to the timepiece module 10 of the second embodiment, the metal members in the timepiece module 10 are less likely to exert a bad influence on transmission/reception of radio waves by the antenna plate 17.

FIG. 6 is a plan view of the electronic timepiece 1 of a third embodiment, showing the positional relationship between the casing 12 and the antenna plate 17 in the electronic timepiece 1.

In the electronic timepiece 1 of the third embodiment, the casing 12, the interior cover 124 in particular, does not overlap the antenna plate 17 in plan view. Further, in the third embodiment, the back cover 123, which is not shown in FIG. 6, is a non-metallic member made of resin or the like. That is, in the second region R2, not only the metal parts in the timepiece module 10 but also the metal parts of the electronic timepiece 1 are not disposed. This can further improve the sensitivity of the plate-like antenna (antenna plate 17) of the electronic timepiece 1 for transmission/reception of radio wave.

As described above, the timepiece module 10 of the above embodiment (s) includes the circuit board 13 having the lower surface (first surface), the antenna plate 17 (plate-like antenna) extending upright in the direction to be away from the lower surface of the circuit board 13, and the fixing member 14 and electronic components on the circuit board 13 as a metal member (s). The metal member is entirely disposed outside the first region R1 that extends from the plate surface 17a of the antenna plate 17 outward in the normal direction of the antenna plate 17 and outside the second region R2 that coincides with the antenna plate 17 in plan view (bottom view) viewed from above the lower surface (from the bottom side).

In an electronic timepiece or the like not having room in size, it is difficult to simply separate all metal components from a plate-like antenna on a substrate (board) with the arrangement as disclosed in JP 2018-146240 A. However, if a compromise is made in the distance to separate, decrease in the sensitivity of an antenna cannot be suppressed sufficiently. In order to deal with these, the timepiece module 10 of the above embodiment (s) has the antenna plate 17 standing on the circuit board 13. The timepiece module 10 is configured such that no metal members are disposed in the frontal direction (outward in the normal direction of the plate surface 17a) of the antenna plate 17 as well as in the upward and downward directions of the antenna plate 17, the directions being along those of the circuit board 13. This enables the electronic timepiece 1, in which the antenna plate 17 is sandwiched between the back cover 123 and the display screen and it has been therefore difficult to increase the transmitting/receiving sensitivity of the antenna plate 17, to efficiently receive/transmit radio waves from its side. Further, the antenna plate 17 arranged upright near the periphery of the circuit board 13 makes it easier to exclude the other metal members from the front of the antenna plate 17 than the conventional antenna's arrangement.

The metal member may include the fixing member 14 that fixes a plurality of structures (battery housing 160, upper housing 130, display 11, circuit board 13, etc.) overlapping one another vertically (in the up-down direction, top-bottom direction or plan view), the plurality of structures including the circuit board 13. The fixing member 14 may include the planar part 142 in the direction along the circuit board 13 and the fitting part (s) 141 fitted to the lateral surface of at least one of the plurality of structures. The fitting part (s) 141 is entirely disposed outside the first region R1, which is the region in the frontal direction of the antenna plate 17, and the second region R2.

Thus, the fixing member 14 is disposed off the position of the antenna plate 17, or the antenna plate 17 is disposed off the positions of the fitting parts 141 of the fixing member 14. This can appropriately improve the sensitivity of the antenna plate 17 for transmission/reception of radio waves.

The metal member may include the fixing member 14 that fixes a plurality of structures overlapping one another in plan view, the plurality of structures including the circuit board 13. The fixing member 14 may include the planar part 142 that spreads parallel to the circuit board 13. The planar part 142 is entirely disposed outside the first region R1 and the second region R2. The fixing member 14 having the shape and the positional relationship that exert little influence on transmission/reception of radio waves by the antenna plate 17 can appropriately improve the sensitivity of the antenna plate 17 of the timepiece module 10 for transmission/reception of radio waves.

The metal member may be entirely disposed outside the third region R3 defined by extending the antenna plate 17 parallel to the first surface (lower surface) of the circuit board 13 and the plate surface 17a of the antenna plate 17. That is, no metal members are present on the right and the left of the upright antenna plate 17 as well as above and under the upright antenna plate 17. This further reduces the influence on an electromagnetic field relevant to radio waves to be transmitted/received and can further improve the sensitivity of the timepiece module 10 for transmission/reception of radio waves.

The timepiece module 10 may further include the battery 16. The metal member may include the electronic components 18. The battery 16 and the electronic components 18 may be disposed above the lower surface (on the bottom side) of the circuit board 13. The electronic components 18 may be disposed, in plan view, outside the fourth region R4 between the antenna plate 17 and the battery 16.

Thus, no metal members, such as electronic components on the circuit board 13, are disposed in the vicinity of the antenna plate 17, the vicinity including the first region R1 and the second region R2 described above. The timepiece module 10 therefore can appropriately transmit/receive radio waves with less influence of metal on radio waves to be transmitted/received.

The electronic timepiece 1 of the above embodiment (s) includes the timepiece module 10 described above and the casing 12 that houses the timepiece module 10. This electronic timepiece 1 can transmit/receive radio waves more stably although it is a small electronic device.

The casing 12 may include the bezel 121 having an opening (12a) and the case body 122 that covers at least the side of the timepiece module 10. The bezel 121 may be made of metal and entirely disposed outside the second region R2. The shape of the bezel 121 and the positioning relationship in which the bezel 121 made of metal is not disposed in the upward and downward directions along the plate surface 17a of the antenna plate 17 can suppress decrease in the sensitivity of the electronic timepiece 1 for transmission/reception of radio waves.

The case body 122 may be made of resin and include a part disposed in the first region R1. In this case, since the case body 122 is not a metal member, it does not exert a bad influence on transmission/reception of radio waves by the antenna plate 17. Since the case body 122 does not reduce the sensitivity for transmission/reception of radio waves, the electronic timepiece 1 can transmit/receive radio waves more stably.

The casing 12 may include the interior cover 124 that supports at least the timepiece module 10. The interior cover 124 may be partly disposed along the outer surface of the timepiece module 10. The interior cover 124 may be made of metal and entirely disposed outside the second region R2. Thus, the electronic timepiece 1 may have the interior cover 124 to fix the timepiece module 10 to the case body 122 so that the timepiece module 10 is supported by the case body 122. In this case, the shape of the interior cover 124 and the positional relationship between the interior cover 124 and the antenna plate 17 are appropriately determined, which can suppress decrease in the sensitivity of the electronic timepiece 1 for transmission/reception of radio waves.

The contents of the present disclosure are merely examples and can be modified in a variety of respects.

For example, in the above embodiment (s), the antenna plate 17 is rectangular, but not limited thereto. The antenna plate 17 may have somewhat rounded corners. Further, the antenna plate 17 may be somewhat inclined with respect to the rear surface (first surface) of the circuit board 13.

Further, in the above embodiment (s), the antenna plate 17 is a monopole antenna with only one part (leg 171) that the antenna plate 17 is provided with connected to the antenna adjustment circuit 134, but not limited thereto. The antenna plate 17 may be used in a dipole antenna.

Further, in the above embodiment (s), on the lower surface of the circuit board 13, some electronic components are present on the opposite side of the battery 16 (and the vibration motor 15) from the antenna plate 17 in plan view, but this is not a limitation. On the lower surface of the circuit board 13, no electronic components (which may exclude connectors to the outside) may be present. This can further improve the sensitivity for transmission/reception of radio waves.

Further, the material of the antenna plate 17 is not particularly limited as far as the antenna plate 17 can maintain its upright state regardless of shocks to the electronic timepiece 1 and has a necessary degree of electrical conductivity.

Further, the antenna plate 17 may not be oriented such that the radial direction from the center of the timepiece module 10 and the abovementioned normal direction coincide. The antenna plate 17 may be inclined with respect to the inner lateral surface of the casing 12.

Further, a communicator including the antenna plate 17 may perform only one of transmission and reception of radio waves.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-036201, filed Mar. 9, 2023 which is hereby incorporated by reference wherein in its entirety.

1. A timepiece module comprising:
a circuit board having a first surface;
a plate-like antenna extending in a direction to be away from the first surface of the circuit board; and
a metal member entirely disposed outside a first region that extends from a plate surface of the antenna outward in a normal direction of the antenna and outside a second region that coincides with the antenna in plan view viewed from above the first surface.

2. The timepiece module according to claim 1,
wherein the metal member includes a fixing member that fixes a plurality of structures overlapping one another in the plan view, the plurality of structures including the circuit board, and
wherein the fixing member includes a planar part in a direction along the circuit board and a fitting part fitted to a lateral surface of at least one of the plurality of structures.

3. The timepiece module according to claim 1,
wherein the metal member includes a fixing member that fixes a plurality of structures overlapping one another in the plan view, the plurality of structures including the circuit board, and
wherein the fixing member includes a planar part that spreads parallel to the circuit board.

4. The timepiece module according to claim 1, wherein the metal member is entirely disposed outside a third region defined by extending the antenna parallel to the first surface and the plate surface of the antenna.

5. The timepiece module according to claim 1, further comprising a battery that is disposed above the first surface of the circuit board,
wherein the metal member includes at least one electronic component that is disposed above the first surface, and
wherein the at least one electronic component is disposed, in plan view, outside a fourth region between the antenna and the battery.

6. An electronic timepiece comprising:
the timepiece module according to claim 1; and
a case that houses the timepiece module.

7. The electronic timepiece according to claim 6,
wherein the case includes a bezel having an opening and a case body that covers at least a side of the timepiece module, and
wherein the bezel is made of metal and entirely disposed outside the second region.

8. The electronic timepiece according to claim 7, wherein the case body is made of resin and at least partly disposed in the first region.

9. The electronic timepiece according to claim 6,
wherein the case includes an interior cover that supports at least the timepiece module, and
wherein the interior cover is partly disposed along an outer surface of the timepiece module, made of metal, and entirely disposed outside the second region.

10. An electronic timepiece comprising:
the timepiece module according to claim 2; and
a case that houses the timepiece module.

11. The electronic timepiece according to claim 10,
wherein the case includes a bezel having an opening and a case body that covers at least a side of the timepiece module, and
wherein the bezel is made of metal and entirely disposed outside the second region.

12. The electronic timepiece according to claim 11, wherein the case body is made of resin and at least partly disposed in the first region.

13. The electronic timepiece according to claim 10,
wherein the case includes an interior cover that supports at least the timepiece module, and
wherein the interior cover is partly disposed along an outer surface of the timepiece module, made of metal, and entirely disposed outside the second region.

14. An electronic timepiece comprising:
the timepiece module according to claim 3; and
a case that houses the timepiece module.

15. The electronic timepiece according to claim 14,
wherein the case includes a bezel having an opening and a case body that covers at least a side of the timepiece module, and
wherein the bezel is made of metal and entirely disposed outside the second region.

16. The electronic timepiece according to claim 15, wherein the case body is made of resin and at least partly disposed in the first region.

17. The electronic timepiece according to claim 14,
wherein the case includes an interior cover that supports at least the timepiece module, and
wherein the interior cover is partly disposed along an outer surface of the timepiece module, made of metal, and entirely disposed outside the second region.
